(19) United States
(12) Patent Application Publication
(10) Pub. No.: US 2013/0340506 A1
(43) Pub. Date: Dec. 26, 2013

(54) METHOD FOR DETECTING PRESENCE OF LIQUID MATERIAL

(71) Applicant: Taiyo Nippon Sanso Corporation, Tokyo (JP)

(72) Inventor: Katsumasa SUZUKI, Tsukuba-shi (JP)

(21) Appl. No.: 13/923,285

(22) Filed: Jun. 20, 2013

(30) Foreign Application Priority Data
Jun. 25, 2012 (JP) 2012-141944

(51) Int. Cl. G01N 11/02

(52) U.S. Cl. CPC G01N 11/02
USPC 73/53.01

(57) ABSTRACT

The object of the present invention is to provide a method for detecting the presence of liquid material which can reliably detect the presence of the liquid material stored in a liquid material storage tank without depending on the viscosity of the liquid material, and prevent process failures caused by the shortage of the liquid material supplied to a place where the liquid material is used, and the present invention provides a method for detecting the presence of liquid material in a liquid material storage tank when the liquid material filled in the liquid material storage tank is supplied to a place where the liquid material is used through a buffer tank, wherein the method includes: a flow rate-measuring step in which the flow rate of a fluid flowing through a liquid material-supplying line is continuously measured using a fluid flow meter which is fixed in the liquid material-supplying line for supplying the liquid material in the liquid material storage tank into the buffer tank; and a presence-detecting step for the liquid material in which the presence of the liquid material in the liquid material storage tank is detected based on the flow rate of the fluid measured by the fluid flow meter.

### BACKGROUND OF THE INVENTION

1. Field of the Invention

The present invention relates to a method for detecting the presence of liquid material in a liquid material storage tank when the liquid material in the liquid material storage tank is sent to a place where the liquid material is used through a buffer tank.

Priority is claimed on Japanese Patent Application No. 2012-141944 filed Jun. 25, 2012, the contents of which are incorporated herein by reference.

2. Related Art

In order to manufacture micro-electronics devices such as semiconductor integrated devices or liquid crystal panels, it is necessary to form a film of various materials on a substrate.

As the film-forming method, a PVD (physical vapor deposition) method and CVD (chemical vapor deposition) method are generally known.

In a film-forming method using a CVD method, various kinds of liquid material such as Si(OC₂H₅)₄ (TEOS), TiCl₄ (titanium tetrachloride), SiH(N(CH₃)₂)₃ (tris(dimethylamino)silane, 3DMAS) or Ga(CH₃)₃ (trimethyl gallium) are used.

As a method for supplying the liquid material, a method has been used in which a gas phase component under about vapor pressure is supplied to a chamber together with a carrier gas by supplying and introducing an inert gas, such as nitrogen, and helium, which is the carrier gas, into a liquid phase in a liquid material storage tank filled with the liquid material, that is, bubbling.

As another method for supplying the liquid material, there is a method in which the compression liquid material is fed in a liquid state by introducing compression gas, for example, inert gas such as nitrogen and helium, into a gas phase in the liquid material storage tank to provide compression conditions inside the liquid material storage tank.

The method for feeding the compression liquid material in a liquid state can be roughly divided into two methods.

That is, a method (abbreviated as “a liquid flow rate control-vaporization method” below) in which the flow rate of the compression liquid material is controlled using a liquid-mass flow controller, and then the liquid material is supplied while vaporizing at a downstream step using a vaporizer and a method (abbreviated as “a vaporization-liquid flow rate control method” below) in which the compression liquid material is vaporized, and then the gas is supplied while controlling the flow rate of the gas.

The liquid flow rate control-vaporization method is the most common liquid material-supplying method at the present time. When the liquid flow rate control-vaporization method is used, the liquid material is not subjected to high temperatures until just before the place where the liquid material is used. Therefore, it is possible to prevent the deterioration of the liquid material compared with the vaporization-liquid flow rate control method.

On the other hand, the flow rate of the liquid material is controlled as gas using a gas mass-flow controller which is positioned downwardly to the vaporizer in the vaporization-liquid flow rate control method. Therefore, the method has superior control accuracy compared with the liquid flow rate control-vaporization method.

Whenever either the liquid flow rate control-vaporization method or the vaporization-liquid flow rate control method is used, the place where the liquid material is used is, for example, a semiconductor-manufacturing device such as a film-forming device, and the liquid material is lacking, the liquid material is not supplied to the semiconductor-manufacturing device and this causes process defects. Therefore, it is important to detect the presence of the liquid material in the liquid material storage tank.

Due to this, a method for detecting the residual amount of the liquid material in the liquid material storage tank has been widely investigated.

Japanese Unexamined Patent Application, First Publication No. 2002-162282 discloses a method for detecting the level of the liquid surface by inserting a sensor probe inside of the tank.

In addition, Japanese Unexamined Patent Application, First Publication No. 2000-128181 discloses a method for detecting a residual amount of the liquid material based on a relationship between the filling amount of the liquid material and the capacitance by providing an electrode inside and outside the tank.

However, since the sensor probe or the electrode is in contact with the liquid material in the tank, the sensor probe or the electrode may be easily damaged depending on the kinds of the liquid material in the tank in both of the methods disclosed in these patent documents.

In order to solve the problems in the methods disclosed in these patent documents, Japanese Unexamined Patent Application, First Publication No. 2002-328055 discloses a method for optically detecting the liquid surface by providing windows facing each other to the liquid material storage tank. Specifically, a projector is fixed on the outside of one window and an optical receiver is fixed on the outside of the other window opposite to the window provided with the projector in Japanese Unexamined Patent Application, First Publication No. 2002-328055.

The method uses the fact that the intensity of light received changes depending on the existence and non-existence of the liquid material in the light path.

However, when the liquid material having high viscosity is filled in the liquid material storage tank, the liquid material is supplied from the liquid material storage tank to the place where the liquid material is used, and even when the surface of the liquid material is lower than the window, the detection failure of the surface of the liquid material may be caused because of adhesion of the liquid material to the surface of the window in the method disclosed in Japanese Unexamined Patent Application, First Publication No. 2002-328055.

### SUMMARY OF THE INVENTION

The object of the present invention is to provide a method for detecting the presence of liquid material which can reliably detect the presence of the liquid material stored in a liquid material storage tank without depending on the viscosity of the liquid material, and prevent process failures caused by the failure (shortage) of liquid material supplied to a place where the liquid material is used.

In order to achieve the object, the present invention provides a method for detecting the presence of liquid material in a liquid material storage tank when the liquid material filled in the liquid material storage tank is supplied to a place where the liquid material is used through a buffer tank, wherein the method includes:

a flow rate-measuring step in which the flow rate of a fluid flowing through a liquid material-supplying line is continuously measured using a fluid flow meter which is fixed in the liquid material-supplying line for supplying the liquid material in the liquid material storage tank into the buffer tank;

a presence-detecting step for the liquid material in which the presence of the liquid material in the liquid material storage tank is detected based on the flow rate of the fluid measured by the fluid flow meter.

In the method for detecting the presence of liquid material, it is preferable that when the fluid is judged as gas based on the variation of flow rate of the fluid, the non-presence of the liquid material in the liquid material storage tank be detected, and when the fluid is judged as the liquid material containing no gas based on the variation of flow rate of the fluid, the presence of the liquid material in the liquid material storage tank be detected in the presence-detecting step for the liquid material.

In addition, in the method for detecting the presence of liquid material, it is preferable that when the fluid is judged as the liquid material containing gas based on the variation of flow rate of the fluid, little remaining of the liquid material in the liquid material storage tank be detected in the presence-detecting step for the liquid material.

In addition, in the method for detecting the presence of liquid material, it is preferable that the place where the liquid material is used is a film formation device or an analyzing device.

Furthermore, it is also preferable that the liquid material be a film-forming material used in the film formation device.

According to the method for detecting the presence of liquid material of the present invention, when the liquid material is supplied to the place where the liquid material is used, the flow rate of the fluid flowing in the liquid material-supplying line is continuously measured using the liquid flow meter fixed in the liquid material-supplying line for supplying the liquid material in the liquid material storage tank into the buffer tank. Thereby, it is possible to detect the non-presence of the liquid material in the liquid material storage tank based on the variation of the flow rate of the fluid when the fluid is judged as gas without depending on the viscosity of the liquid material. In addition, when the fluid is judged as the liquid material containing no gas, it is possible to detect the presence of the liquid material in the liquid material storage tank.

In addition, the liquid material in the liquid material storage tank is stored in the buffer tank and then supplied to the place where the liquid material is used from the buffer tank, without directly supplying to the place where the liquid material is used.

Therefore, it is possible to supply the liquid material filled in the liquid material storage tank into the buffer tank so as not to use up the liquid material in the buffer tank. Thereby, even when the liquid material in the liquid material storage tank is used up, the liquid material in the buffer tank is not used up.

Therefore, it is possible to reliably detect the presence of the liquid material in the liquid material storage tank without depending on the viscosity of the liquid material, and prevent process failures (supply shortage) caused by the shortage of liquid material supplied to a place where the liquid material is used.

### BRIEF EXPLANATION OF FIGURES

FIG. 1 is a diagram showing an outline of a liquid material-supplying device used to carry out the method for detecting the presence of liquid material according to one embodiment of the present invention.

FIG. 2 is an enlarged view showing a part including an operation panel or a speaker in the place where the liquid material is used.

### PREFERRED EMBODIMENTS OF THE PRESENT INVENTION

Below, the embodiments of the present invention will be explained referring to figures. Moreover, figures used in the following explanation are for explaining the composition of the embodiments of the present invention, and the size or the thickness of parts may be different from those of an actual liquid material-supplying device.

### First Embodiment

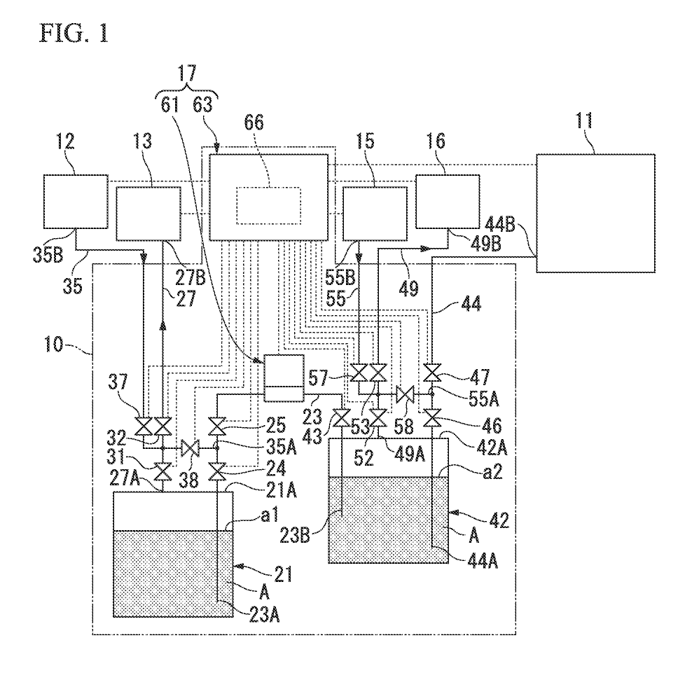

FIG. 1 is a diagram showing an outline of a liquid material-supplying device used to carry out the method for detecting the presence of liquid material according to one embodiment of the present invention.

Before explaining the embodiment of the method for detecting the presence of liquid material, a liquid material-supplying device 10 used to carry out the method for detecting the presence of liquid material will be explained.

As shown in FIG. 1, the liquid material-supplying device 10 includes a detecting device 17 for detecting the presence of liquid material, a liquid material storage tank 21, a first liquid material-supplying line 23, first to thirteenth valves 24, 25, 31, 32, 37, 38, 43, 46, 47, 52, 53, 57, and 58, a first vent line 27, a first compression gas-supplying line 35, a buffer tank 42, a second liquid material-supplying line 44, a second vent line 49, a second compression gas-supplying line 55, a liquid flow meter 61, and a control portion 63. Briefly, the detecting device 17 for detecting the presence of liquid material includes the liquid flow meter 61 and the control portion 63.

The liquid material storage tank 21 is a tank filled with the liquid material A. The liquid material storage tank 21 includes a lid 21A, and first and second penetrations (not shown in figures). The first and second penetrations penetrate the lid 21A. One end 27A of the first vent line 27 is installed in the first penetration.

The first liquid material-supplying line 23 is installed in the second penetration such that the liquid material-supplying line 23 extends inside the liquid material storage tank 21.

The liquid material storage tank 21 is connected with the buffer tank 42 such that the liquid material A can be supplied into the buffer tank 42 through the first liquid material-supplying line 23. The liquid material storage tank 21 supplies the liquid material A to a place 11 where the liquid material is used through the buffer tank 42.

Examples of the place 11 where the liquid material is used include a semiconductor-manufacturing device, for example, a film-forming device, such as a PVD device, and CVD device, and an analyzing device such as FT-IR.

When the place 11 where the liquid material is used is the CVD device, examples of the liquid material A, which is stored in the liquid material storage tank 21, include Si(OC₂H₅)₄ (TEOS)), TiCl₄(titanium tetrachloride), SiH(N(CH₃)₂)₃ (tris(dimethylamino) silane (3DMAS)), and Ga(CH₃)₃ (trimethyl gallium). These liquid materials A readily react with oxygen and moisture in air.

When a material which readily reacts with oxygen or moisture in air is used as the liquid material A, and the one end 23A of the first liquid material-supplying line 23 or the first vent line 27 is installed or removed from the lid 21A, it is necessary to sufficiently purge the connection portion between the lid 21A and the first liquid material-supplying line 23 or the connection portion between the lid 21A and the first vent line 27.

As the material for the liquid material storage tank 24, any material can be used as long as it does not react with the liquid material A filled in the liquid material storage tank 24 and can maintain the air tightness of the liquid material storage tank 24. Specifically, for example, stainless steel or TEFLON® can be used.

The capacity of the liquid material storage tank 21 can be adjusted depending on the capacity of the liquid material A to be stored, and is, for example, several dozen cm³ to a few thousands cm³.

The first liquid material-supplying line 23 is a line for supplying the liquid material A filled in the liquid material storage tank 21 into the buffer tank 42. One end 23A of the first liquid material-supplying line 23 is around the bottom of the liquid material storage tank 21 and the other end 23B thereof is inside of the buffer tank 42.

The one end 23A of the first liquid material-supplying line 23 is arranged near the bottom of the liquid material storage tank 21.

It is possible to supply almost all of the liquid material A filled in the liquid material storage tank 21 by arranging the one end 23A of the first liquid material-supplying line 23 so as to position close to the bottom of the liquid material storage tank 21 as explained above.

The other end 23B of the first liquid material-supplying line 23 is positioned so as to immerse into the liquid material A filled in the buffer tank 42.

Due to this structure, the liquid material A, which is transferred through the first liquid material-supplying line 23, is not supplied upwardly from the surface a2 of the liquid material A filled in the buffer tank 42. Thereby, it is possible to prevent the generation of gas (babbles) in the liquid material A supplied to the place 11 where the liquid material is used from the buffer tank 42.

When a sufficient amount of the liquid material A is in the liquid material storage tank 21, the first liquid material-supplying line 23 supplies the liquid material A containing no gas in the buffer tank 42.

In contrast, when the residual amount of the liquid material A in the liquid material storage tank 21 is little, and the liquid material A contains gas, that is, just before the liquid material A in the liquid material storage tank 21 is used up, the first liquid material-supplying line 23 supplies the liquid material A containing gas into the buffer tank 42.

Furthermore, when the liquid material A in the liquid material storage tank 21 is used up, the first liquid material-supplying line 23 supplies gas into the buffer tank 42.

The first valve 24 is fixed to the first liquid material-supplying line 23 outside of the liquid material storage tank 21, and near the lid 21A. The first valve 24 is electrically connected with the control portion 63.

The second valve 25 is fixed to the first liquid material-supplying line 23, which is downstream with respect to the first valve 24. The second valve 25 is electrically connected with the control portion 63.

The first vent line 27 is a line for purging the line between the lid 21A and the connection portion between the first liquid material-supplying line 23 and the first vent line 27. The first vent line 27 is connected with the first compression gas-supplying line 35.

Thereby, the first vent line 27 between the lid 21A and the connection portion between the first vent line 27 and the first compression gas-supplying line 35 acts as a compression gas-supplying line for supplying compression gas into the liquid material storage tank 21.

One end 27A of the first vent line 27 is installed in the first penetration (not shown in figures) formed in the lid 21A, and the other end 27B is connected with a first exhaust apparatus 13 which is electrically connected with the control portion 63. The one end 27A of the first vent line 27 is positioned higher than the surface a1 of the liquid material A filled in the liquid material storage tank 21.

It is possible to prevent the supply of the compression gas in the liquid material A by positioning the one end 27A of the first vent line 27 higher than the surface a1 of the liquid material A. Therefore, it is also possible to prevent the supply of the liquid material A containing gas in the buffer tank 42.

The third valve 31 is fixed to the first vent line 27, which is between the lid 21A and the connection portion between the first compression gas-supplying line 35 and the first vent line 27. The third valve 31 is electrically connected with the control portion 63.

The fourth valve 32 is fixed to the first vent line 27, which is between the exhaust apparatus 13 and the connection portion between the first compression gas-supplying line 35 and the first vent line 27. The fourth valve 32 is electrically connected with the control portion 63.

One end 35A of the first compression gas-supplying line 35 is connected with the first liquid material-supplying line 23, which is between the first valve 24 and the second valve 25. The other end 35B of the first compression gas-supplying line 35 is connected with the first compression gas source 12, which is electrically connected with the control portion 63.

In addition, the first compression gas-supplying line 35 is connected with the first vent line 27.

The first compression gas-supplying line 35 supplies compression gas supplied from the first compression gas source 12 to a space, that is, a gas phase, in the liquid material storage tank 21 between the lid 21A and the surface a1 of the liquid material A filled in the liquid material storage tank 21.

As the compression gas, rare gas such as nitrogen, helium, and argon can be used. However, any gas can be used as long as it does not react with the liquid material A, without limitations.

Moreover, it is possible to fix a gas flow meter for measuring the flow rate of the compression gas to the first compression gas-supplying line 35, which is not shown in figures. As the gas flow meter, a flow meter having high air tightness is preferably used. For example, a float-type flow meter, or a gas mass flow meter, which is commercially available, can be used.

The fifth valve 37 is fixed to the first compression gas-supplying line 35, which is between the first compression gas-supplying source 12 and the connection portion between the first vent line 27 and the first compression gas-supplying line 35. The fifth valve 37 is electrically connected with the control portion 63.

The sixth valve 38 is fixed to the first compression gas-supplying line 35, which is between the connection portion between the first vent line 27 and the first compression gas-supplying line 35 and the connection portion between the first liquid material-supplying line 23 and the first compression gas-supplying line 35. The sixth valve 38 is electrically connected with the control portion 63.

The buffer tank 42 is positioned between the liquid material storage tank 21 and the place 11 where the liquid material is used.

The buffer tank 42 is connected with the liquid material storage tank 21 through the first liquid material-supplying line 23. The liquid material A is supplied in the buffer tank 42 from the liquid material storage tank 21 through the first liquid material-supplying line 23.

In addition, the buffer tank 42 is also connected with the place 11 where the liquid material A is used through the second liquid material-supplying line 44. The buffer tank 42 supplies the liquid material A to the place 11 where the liquid material A is used through the second liquid material-supplying line 44.

As the material for the buffer tank 42, any material can be used as long as it does not react with the liquid material A filled in the buffer tank 42 and can maintain the air tightness of the buffer tank 42. Specifically, for example, stainless steel or TEFLON® can be used.

The capacity of the buffer tank 42 can be adjusted depending on the capacity of the liquid material A used, and is, for example, several dozen cm³ to a few thousands cm³.

By the way, the second liquid material-supplying line 44 is electrically connected with the control portion 63, and has a liquid flow meter for measuring the flow rate of the liquid material A flowing through the second liquid material-supplying line 44.

As explained above, it is possible to detect the amount of the liquid material A supplied to the place 11 where the liquid material A is used from the buffer tank 42 by fixing the liquid flow meter to the second liquid material-supplying line 44. Thereby, it is possible to supply the amount of the liquid material A which is required by the place 11 where the liquid material A is used from the liquid material storage tank 21 to the buffer tank 42.

In other words, it is possible to supply the liquid material A filled in the liquid material storage tank 21 into the buffer tank 21 so as not to use up the liquid material A in the buffer tank 42 by storing the liquid material A in the liquid material storage tank 21 in the buffer tank 42, and supplying the liquid material A from the buffer tank 42 to the place 11 where the liquid material A is used, instead of supplying directly the liquid material A in the liquid material storage tank 21 to the place 11 where the liquid material A is used.

Therefore, when the liquid material A is supplied to the place 11 where the liquid material A is used, and even when the liquid material A in the liquid material storage tank 21 is used up, the liquid material A in the buffer tank 42 is never used up. As a result, it is possible to prevent process failures caused by the shortage of liquid material A supplied to a place 11 where the liquid material is used. For example, when the place 11 where the liquid material A is used is a film formation device, it is possible to prevent film formation failures.

Moreover, it is also possible to supply the liquid material A in the liquid material storage tank 21 into the buffer tank 42 so as to link with the supplied amount of the liquid material A from the buffer tank 42 without fixing the liquid flow meter to the second liquid material-supplying line 44.

The seventh valve 43 is fixed to the first liquid material-supplying line 23, which is between the lid 42A of the buffer tank 42 and the liquid flow meter 61. The seventh valve 43 is electrically connected with the control portion 63.

The second liquid material-supplying line 44 is a line for supplying the liquid material A filled in the buffer tank 42 to the place 11 where the liquid material A is used. One end 44A of the second liquid material-supplying line 44 is positioned around the bottom of the buffer tank 42, and the other end 44B is connected with the place 11 where the liquid material A is used.

As explained above, the one end 44A of the second liquid material-supplying line 44 is arranged near the bottom of the buffer tank 42.

It is possible to supply almost all of the liquid material A filled in the buffer tank 42 by arranging the one end 44A of the second liquid material-supplying line 44 close to the bottom of the buffer tank 42.

The eighth valve 46 is fixed to the second liquid material-supplying line 44 outside of the buffer tank 42, and near the lid 42A. The eighth valve 46 is electrically connected with the control portion 63.

The ninth valve 47 is fixed to the second liquid material-supplying line 44, which is downstream with respect to the eighth valve 46. The ninth valve 47 is electrically connected with the control portion 63.

The second vent line 49 is a line for purging the connection portion between the second vent line 49 and the tenth valve 52, and the connection between the second liquid material-supplying line 44 and the eighth valve 46. The second vent line 49 is connected with the second compression gas-supplying line 55.

Thereby, the second vent line 49, which is between the lid 42A and the connection portion between the second compression gas-supplying line 55 and the second vent line 49, acts as a compression gas-supplying line for supplying compression gas into the buffer tank 42.

One end 49A of the second vent line 49 is installed in the first penetration (not shown in figures) formed in the lid 42A, and the other end 49B is connected with a second exhaust apparatus 16 which is electrically connected with the control portion 63. The one end 49A of the second vent line 49 is positioned higher than the surface a2 of the liquid material A filled in the buffer tank 42.

It is possible to prevent the supply of the compression gas in the liquid material A by positioning the one end 49A of the second vent line 49 higher than the surface a2 of the liquid material A filled in the buffer tank 42. Therefore, it is also possible to prevent the supply of the liquid material A containing gas to the place 11 where the liquid material A is used.

The tenth valve 52 is fixed to the second vent line 49, which is between the lid 42A and the connection portion between the second compression gas-supplying line 55 and the second vent line 49. The tenth valve 52 is electrically connected with the control portion 63.

The eleventh valve 53 is fixed to the second vent line 49, which is between the second exhaust apparatus 16 and the connection portion between the second compression gas-supplying line 55 and the second vent line 49. The eleventh valve 53 is electrically connected with the control portion 63.

One end 55A of the second compression gas-supplying line 55 is connected with the second liquid material-supplying line 44, which is between the eighth valve 46 and the ninth valve 47, and the other end 55B thereof is connected with the second compression gas-supplying source 15 which is electrically connected with the control portion 63.

In addition, the second compression gas-supplying line 55 having the ends 55A and 55B is connected with the second vent line 49.

The second compression gas-supplying line 55 supplies compression gas supplied from the second compression gas source 15 to a space, that is, a gas phase, in the buffer tank 42 between the surface a2 of the liquid material A filled in the buffer tank 22 and the lid 42A.

As the compression gas, rare gas such as nitrogen, helium, and argon can be used. However, any gas can be used as long as it does not react with the liquid material A, without limitations.

The liquid flow meter 61 is fixed to the first liquid material-supplying line 23, which is between the second valve 25 and the seventh valve 43.

When the place 11 where the liquid material A is used is the film formation device, it is preferable that a liquid flow rate control portion be fixed to the second liquid material-supplying line 44, which is before the place 11 where the liquid material A is used and that an evaporation-liquid flow control portion be fixed between the liquid flow meter 61 and the place 11 where the liquid material A is used, which are not shown in FIG. 1.

When the liquid flow rate control portion (not shown in Figures) is fixed, since the liquid material A is heated and evaporated just before the place 11 where the liquid material A is used, it is possible to change in quality the liquid material A.

When the evaporation-liquid flow control portion (not shown in Figures) is fixed instead of the liquid flow rate control-evaporation portion, since the flow rate of the liquid material A is controlled as gas, it is possible to control the flow rate of the liquid material A with high control accuracy compared with a case using the liquid flow rate control-evaporation portion.

The liquid flow meter 61 is electrically connected with the control portion 63. When the liquid material A is supplied to the place 11 where the liquid material A is used, the liquid flow meter 61 measures continuously the flow rate of the fluid flowing through the first liquid material-supplying line 23. Specifically, for example, when the place 11 where the liquid material A is the film formation device, during film formation, the liquid flow meter 61 measures continuously the flow rate of any one of the liquid material A as liquid, the liquid material A containing gas, and gas which is flowing through the first liquid material-supplying line 23. The liquid flow meter 61 sends the measured data for flow rate of the fluid to the control portion 63 in real time.

When the liquid material containing no gas is supplied into the buffer tank 42, the liquid flow meter 61 measures the flow rate of the liquid material A which is equal to the flow rate of the liquid material A supplied from the liquid material storage tank 21 into the buffer tank 42. In this case, the flow rate of the liquid material A is substantially fixed. Therefore, the variation of the flow rate of the liquid material A is very small.

When the amount of the liquid material A filled in the liquid material storage tank 21 decreases, and the liquid material A containing gas is supplied from the liquid material storage tank 21, the liquid flow meter 61 measures the flow rate of the liquid material A containing gas.

In this case, the variation of the flow rate of the liquid material A containing gas increases due to the influence of gas. Thereby, when the variation of the flow rate of the fluid measured by the liquid flow meter 61 increases, it is possible to detect the fact that the residual amount of the liquid material A in the liquid material storage tank 21 is small.

In addition, when the liquid material A filled in the liquid material storage tank 21 is used up, and gas is supplied from the liquid material storage tank 21, the liquid flow meter 61 measures the flow rate of the gas.

In this case, since the liquid flow meter 61 does not readily measure the flow rate of gas, the variation of the flow rate becomes larger and larger. Due to this, when the variation of the flow rate of the fluid measured by the liquid flow meter 61 is larger and larger, it is possible to detect the consumption of the liquid material A in the liquid material storage tank 21.

It is preferable that the liquid flow meter 61 have high air tightness and that the contact portion with the liquid material A be made of a material having low reactivity to the liquid material A. Examples of the material include SUS. As the liquid flow meter 61, a liquid mass flow meter which is marketed can be used.

In addition, it is preferable that the liquid flow meter 61 enables output of the flow rate information or contact signal as electrical signals.

The control portion 63 controls the first to thirteenth valves 24, 25, 31, 32, 37, 38, 43, 46, 47, 52, 53, 57, and 58, the first compression gas-supplying source 12, the second compression gas-supplying source 15, the first exhaust apparatus 13, and the second exhaust apparatus 16. In other words, the control portion 63 controls generally the liquid material-supplying device 10.

The control portion 63 is electrically connected with the place 11 where the liquid material A is used. The control portion 63 includes a detection portion 66. When the variation of the fluid sent from the liquid flow meter 61 exceeds or is less than the threshold flow rate which is memorized in the control portion 63 in advance, the detection portion 66 detects the fact that the liquid material A in the liquid material storage tank 21 is used up.

In addition, it is also preferable that when the variation of the flow rate exceeds the range which is set in advance, the detection portion 66 detects the shortage of the liquid material A in the liquid material storage tank 21.

It is also possible to detect the small amount of the liquid material A in the liquid material storage tank 21 by setting another threshold other than the thresholds explained above.

When the control portion 63 detects that the amount of the liquid material A in the liquid material storage tank 21 is small, or that the liquid material A in the liquid material storage tank 21 is used up, the control portion 63 sends data for the residual amount of the liquid material A in the liquid material storage tank 21 to the place 11 where the liquid material A is used.

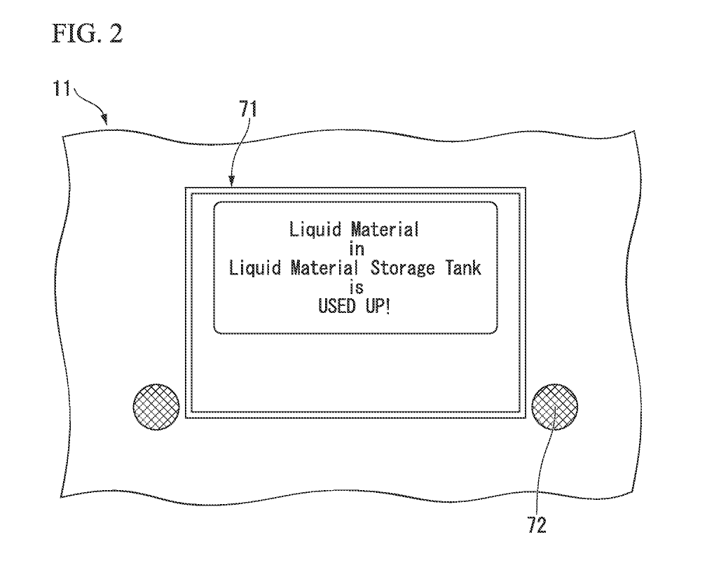

FIG. 2 is an enlarged view showing a part provided with an operation panel and a speaker in the place 11 where the liquid material A is used.

As shown in FIG. 2, the place 11 where the liquid material A is used has the operation panel 71 and the speaker 72. As the operation panel 71, a touch panel for controlling the operation of a semiconductor-manufacturing device, such as a film formation device, or an analyzing device in the place 11 where the liquid material A is used can be used.

As shown in FIG. 2, when the control portion 63 detects the fact that the liquid material A in the liquid material storage tank 21 is used up, and the place 11 where the liquid material A is used receives the data for the presence of the liquid material A, the place 11 where the liquid material A is used displays a message of “Liquid Material in Liquid Material Storage Tank is USED UP!” on the operation panel 71. At the same time, an alarm sound is produced from the speaker 72

Thereby, the operator can recognize that the liquid material A in the liquid material storage tank 21 is used up. Then, it is possible to change the empty liquid material storage tank 21 to another liquid material storage tank filled with the liquid material A without adversely affecting the process in the place 11 where the liquid material A is used.

Moreover, although not shown in FIG. 2, when the control portion 63 detects that the remaining amount of the liquid material A in the liquid material storage tank 21 is small, and the place 11 where the liquid material A is used receives the data for the remaining amount of the liquid material A in the liquid material storage tank 21, the place 11 where the liquid material A is used displays a message of “Remaining Amount of Liquid Material in Liquid Material Storage Tank is SMALL” on the operation panel 71. At the same time, an alarm sound, which is different from the alarm sound when the liquid material A in the liquid material storage tank 21 is used up, is produced.

Thereby, the operator can recognize that the remaining amount of the liquid material A in the liquid material storage tank 21 is small. Then, it is possible to prepare for changing the liquid material storage tank 21.

Next, the method for detecting the presence of the liquid material A in the liquid material storage tank using the liquid material-supplying device 10 shown in FIG. 1 will be explained.

First of all, the fourth valve 32, the sixth valve 38, the eleventh valve 53, and the thirteenth valve 58 are closed. The first valve 24, second valve 25, third valve 31, fifth valve 37, seventh valve 43, eighth valve 46, ninth valve 47, tenth valve 52, and twelfth valve 57 are open.

Then, the compression gas is supplied from the first compression gas-supplying source 12 at a fixed flow rate in the gas phase of the liquid material storage tank 21 through a part of the first compression gas-supplying line 35 and the first vent line 27.

Thereby, the surface a1 of the liquid material A in the liquid material storage tank 21 is pressurized, and the liquid material A is supplied into the buffer tank 42 through the first liquid material-supplying line 23 and the liquid flow meter 61.

Under this condition, the liquid flow meter 61 measures continuously the flow rate of the fluid flowing through the first liquid material-supplying line 23 (flow rate-measuring step), and sends the data for measurement result to the control portion 63 in real time. In other words, under conditions in which the liquid material A in the liquid material storage tank 21 is supplied into the buffer tank 42, the liquid flow meter 61 measures continuously the flow rate of any one of fluid selected from the liquid material A containing no gas, liquid material A containing gas, and gas (flow rate-measuring step), and sends the data for measurement result to the control portion 63 in real time.

Then, in the detection step for detecting the presence of the liquid material, when the variation of the fluid flowing through the first liquid material-supplying line 23 exceeds or is less than the predetermined threshold flow rate which is memorized in advance, the fluid is judged as gas, and it is detected that the amount of the liquid material A in the liquid material storage tank 21 is small.

At this time, as explained above, it detects that an amount of the liquid material A is small using the fact that the variation of the flow rate of the liquid material A containing gas is larger than the variation of the flow rate of the liquid material A containing no gas.

In addition, in the detection step for detecting the presence of the liquid material, when the flow rate of the fluid flowing through the first liquid material-supplying line 23 exceeds or is less than the threshold, which is another threshold for detecting that an amount of the liquid material A in the liquid material storage tank 21 is small, it detects that the liquid material A is not present in the liquid material storage tank 21.

Specifically, it detects that the liquid material A is not present in the liquid material storage tank 21 using the fact that the variation of the flow rate of only gas is larger than the liquid material A containing gas.

Moreover, it is also possible that when the variation of the flow rate of the fluid exceeds a range set in advance, the consumption of the liquid material A in the liquid material storage tank 21 be detected.

In addition, in the detection step for detecting the presence of the liquid material, when the fluid is detected as liquid based on the threshold set in advance, it detects that the liquid material A is sufficiently stored in the liquid material storage tank 21. That is, when the fluid is detected as liquid based on the threshold for detecting that the liquid material A in the liquid material storage tank 21 is small, it detects that the liquid material A is sufficiently stored in the liquid material storage tank 21.

The method for detecting for the presence of liquid material according to this embodiment includes a flow rate-measuring step in which the flow rate of the fluid flowing in the first liquid material-supplying line 23 is continuously measured using the liquid flow meter 61 fixed to the first liquid material-supplying line 23 for supplying the liquid material A in the liquid material storage tank 21 into the buffer tank 42; and a presence-detecting step for the liquid material A in which the presence of the liquid material A in the liquid material storage tank 21 is detected based on the flow rate of the fluid measured by the liquid flow meter 61. Thereby, it is possible to detect the fact that the liquid material A in the liquid material storage tank 21 is used up when the variation of the flow rate of the fluid becomes large, that is, when the fluid is gas, without depending on the viscosity of the liquid material A. In addition, when the variation of the flow rate of the fluid is stable, that is, when the fluid is liquid material A containing no gas, it can be detected that the liquid material storage tank 21 contains the liquid material A.

Thereby, it is possible to reliably detect the presence of the liquid material A in the liquid material storage tank 21 without depending on the viscosity of the liquid material A.

The preferred embodiments are explained above. However, the present invention is not limited to these embodiments, and the constitution of the present invention can be changed as long as the change of the constitution is within the scope of the present invention.

### Example 1

Validation tests were carried out to confirm whether the fact that the liquid material A in the liquid material storage tank 21 was almost used up could be detected using the device shown in FIG. 1.

As the place 11 where the liquid material A is used, a plasma CVD device was used. In addition, a vaporizer and a gas mass flow controller (which are not shown in FIG. 1) were fixed to the second liquid material-supplying line 44 between the plasma CVD device and the ninth valve 47.

In addition, a liquid mass flow controller (not shown in FIG. 1) was also fixed to the second liquid material-supplying line 44, which is upstream relative to the vaporizer and the gas mass flow controller.

At first, as the liquid material A, 500 g of Si(OC₂H₅)₄ (TEOS) was stored in the liquid material storage tank 21 having a capacity of 1500 cm³. In addition, as the liquid material A, 500 g of TEOS was also stored in the buffer tank 42 having a capacity of 1500 cm³. In other words, a sufficient amount of TEOS was filled in the liquid material storage tank 21 and the buffer tank 42.

Furthermore, the supplying amount of TEOS from the gas mass flow controller into the plasma CVD device was set to 0.5 g/min. Thereby, a silicon dioxide film (SiO₂ film) was formed on a semiconductor substrate using the plasma CVD device. At this time, as the compression gas, helium (He) was used.

When the silicon dioxide film was formed by supplying TEOS from the liquid material storage tank 21 and buffer tank 42, the flow rate of the fluid measured by the liquid flow meter 61 was identical to the flow rate measured by the liquid mass flow controller. From this fact, it was confirmed that TEOS containing no gas was supplied from the buffer tank 42 to the place 11 where the TEOS was used.

When TEOS was continuously supplied from the liquid material storage tank 21 and the buffer tank 42 to form the silicon dioxide film, although the measured value of the liquid mass flow controller was maintained at 0.5 g/min, the measured value of the liquid flow meter 61 was varied in a range of 0 to 2.0 g/min.

At this time, the compression gas (helium, He) was supplied through the second compression gas-supplying line 55 to supply the compression gas (helium, He) in the gas phase in the buffer tank 42 and press the surface a2 of TEOS by closing the seventh valve 43, and opening the tenth valve 52 and twelfth valve 57. Thereby, TEOS was supplied to the plasma CVD device through the second liquid material-supplying line 44, and the film-formation process was continued.

At the same time, the liquid material storage tank 21 was removed from the device by closing the first and third valves 24 and 31, and purging the first liquid material-supplying line 23 using the first vent line 27.

Then, when the weight of the liquid material storage tank 21 removed from the device was measured, it could be confirmed that an amount of TEOS in the liquid material storage tank 21 was small.

After that, another liquid material storage tank 21, which was filled with a sufficient amount of TEOS, was installed, and the connection portions were reliably purged.

Then, while the film formation process was interrupted, TEOS was prepared to be supplied from liquid material storage tank 21 into the buffer tank 42. Specifically, after the pressure inside of the liquid material storage tank 21 and buffer tank 42 was adjusted, the first, second, and seventh valves 24, 25, and valve 43 were opened.

Under this condition, when TEOS was supplied again from the liquid material storage tank 21 which had already been exchanged, and the buffer tank 42, it could be confirmed that the flow rate of the fluid measured by the liquid flow meter 61 followed the flow rate of the fluid measured by the liquid mass flow controller.

### Example 2

Validation tests were carried out to confirm whether the fact that the liquid material A in the liquid material storage tank 21 was almost used up could be detected using the device shown in FIG. 1.

As the place 11 where the liquid material A is used, a thermal CVD device was used. In addition, a vaporizer and a gas mass flow controller (which are not shown in FIG. 1) were fixed to the second liquid material-supplying line 44 between the thermal CVD device and the ninth valve 47.

In addition, a liquid mass flow controller (not shown in FIG. 1) was also fixed to the second liquid material-supplying line 44, upstream relative to the vaporizer and the gas mass flow controller.

At first, as the liquid material A, 500 g of SiH(N(CH₃)₂)₃ (3DMAS) was stored in the liquid material storage tank 21 having a capacity of 1500 cm³. In addition, as the liquid material A, 500 g of 3DMAS was also stored in the buffer tank 42 having a capacity of 1500 cm³. In other words, a sufficient amount of 3DMAS was filled in the liquid material storage tank 21 and the buffer tank 42.

Furthermore, the supplying amount of 3DMAS from the gas mass flow controller into the plasma CVD device was set to 0.2 g/min. Thereby, a silicon dioxide film (SiO₂ film) was formed on a semiconductor substrate using the thermal CVD device. At this time, as the compression gas, nitrogen (N₂) was used.

When the silicon dioxide film was formed by supplying 3DMAS from the liquid material storage tank 21 and buffer tank 42, the flow rate of the fluid measured by the liquid flow meter 61 was identical to the flow rate measured by the liquid mass flow controller. From this fact, it was confirmed that 3DMAS containing no gas was supplied from the buffer tank 42 to the place 11 where the 3DMAS was used.

When 3DMAS was continuously supplied from the liquid material storage tank 21 and the buffer tank 42 to form the silicon dioxide film, although the measured value of the liquid mass flow controller was maintained at 0.2 g/min, the measured value of the liquid flow meter 61 was varied in a range of 0 to 1.5 g/min.

At this time, the compression gas (nitrogen, N₂) was supplied through the second compression gas-supplying line 55 to supply the compression gas (nitrogen, N₂) in the gas phase in the buffer tank 42 and press the surface a2 of 3DMAS by closing the seventh valve 43, and opening the tenth valve 52 and twelfth valve 57. Thereby, 3DMAS was supplied to the thermal CVD device through the second liquid material-supplying line 44, and the film-formation process was continued.

At the same time, the liquid material storage tank 21 was removed from the device by closing the first and third valves 24 and 31, and purging the first liquid material-supplying line 23 using the first vent line 27.

Then, when the weight of the liquid material storage tank 21 removed from the device was measured, it could be confirmed that an amount of 3DMAS in the liquid material storage tank 21 was small.

The preferred examples according to the present invention are explained above. However, the present invention is not limited to these examples, and another constitution can be added, the constitution of the present invention can be omitted, replaced with another constitution, or changed as long as the change of the constitution is within the scope of the present invention. The present invention is not limited to any explanations above, and limited by only the Claims enclosed.

1. A method for detecting the presence of liquid material in a liquid material storage tank when the liquid material filled in the liquid material storage tank is supplied to a place where the liquid material is used through a buffer tank, wherein the method includes:
a flow rate-measuring step in which the flow rate of a fluid flowing through a liquid material-supplying line is continuously measured using a fluid flow meter which is fixed in the liquid material-supplying line for supplying the liquid material in the liquid material storage tank into the buffer tank; and
a presence-detecting step for the liquid material in which the presence of the liquid material in the liquid material storage tank is detected based on the flow rate of the fluid measured by the fluid flow meter.

2. The method for detecting the presence of liquid material according to claim 1, wherein, in the presence-detecting step for the liquid material,
when the fluid is judged as gas based on the variation of flow rate of the fluid, the non-presence of the liquid material in the liquid material storage tank is detected, and
when the fluid is judged as the liquid material containing no gas based on the variation of flow rate of the fluid, the presence of the liquid material in the liquid material storage tank is detected.

3. The method for detecting the presence of liquid material according to claim 1, wherein, in the presence-detecting step for the liquid material,
when the fluid is judged as the liquid material containing gas based on the variation of flow rate of the fluid, little remaining of the liquid material in the liquid material storage tank is detected.

4. The method for detecting the presence of liquid material according to claim 1, wherein the place where the liquid material is used is a film formation device or an analyzing device.

5. The method for detecting the presence of liquid material according to claim 4, wherein the liquid material is a film-forming material used in the film formation device.
